(19) United States
(12) Patent Application Publication
(10) Pub. No.: US 2025/0384169 A1
(43) Pub. Date: Dec. 18, 2025

(54) REAL-TIME OVERVOLTAGE MONITORING TO PREVENT UNAUTHORIZED ACCESS VIA TIMING FAULT EXPLOITATION

(71) Applicant: NVIDIA Corporation, Santa Clara, CA (US)

(72) Inventors: Kedar Rajpathak, Pune (IN); Tezaswi Raja, San Jose, CA (US)

(21) Appl. No.: 19/303,172

(22) Filed: Aug. 18, 2025

Related U.S. Application Data
(63) Continuation-in-part of application No. 16/294,788, filed on Mar. 6, 2019.

(51) Int. Cl. G06F 21/81; G06F 21/55; G06F 21/75; G06F 21/78; H02H 1/00; H02H 3/22

(52) U.S. Cl. CPC G06F 21/81; G06F 21/554; G06F 21/755; G06F 21/78; H02H 1/0007; H02H 3/22

(57) ABSTRACT

An over-voltage detection circuit for use with an IC is disclosed. The over-voltage detection circuit comprises first and second portions. The first portion includes a plurality of MOSFET transistors connected in series to ground, a first resistor connected between a virtual supply voltage (VV_{DD}) and the plurality of MOSFET transistors, and a first inverter with an input connected between the first resistor and the plurality of transistors, where VV_{DD} is a scaled down version of voltage applied to the IC (V_{DD}) The second portion includes a second transistor connected to V_{DD} applied to the IC, a pair of MOSFET transistors connected in series between the second transistor and ground, and a second inverter with an input connected between the second resistor and the pair of MOSFET transistors. An output of the second inverter indicates V_{DD} is above an over-voltage level represented by VV_{DD}.

### CROSS REFERENCE TO RELATED APPLICATIONS

This application is a continuation-in-part of application Ser. No. 16/294,788 (the “'788 application”), entitled “Cross Domain Voltage Glitch Detection Circuit for Enhancing Chip Security,” filed on Mar. 6, 2019, the contents of which are incorporated herein by reference in their entirety.

### TECHNICAL FIELD

This application is directed, in general, to security for an integrated circuit (IC) and, more specifically, to detecting when a voltage applied to an integrated circuit (IC) exceeds a level that causes timing faults on the IC.

### BACKGROUND

Protecting ICs against hackers has become increasingly important in recent times. In today's system on a chip ICs (SoC ICs), it is common for cryptographic key(s) to be required to enable access to the SoC ICs. If a hacker can access the IC to obtain its cryptographic key(s), the hacker can then use the cryptographic key(s) to gain access to the IC and take control of it, including causing timing faults that cause instruction skipping, instruction decoding errors, and improper data read and write backs. Further, unauthorized access to the SoC IC may either bypass a device authentication process or enter unauthorized logic through Joint Test Action Group (JTAG) access.

One technique hackers use to gain access to the IC is to very briefly apply an over-voltage to one or more of a plurality of voltage supply pads of the packaged IC (e.g., an “over-voltage attack”), even for a very brief period, e.g., <20 ps. The over-voltage attack can create timing faults on the IC and these timing faults can allow hackers unauthorized access to the IC to, e.g., obtain cryptographic key(s) stored on the IC.

### SUMMARY OF THE DISCLOSURE

In one aspect, an over-voltage detection circuit for use with an integrated circuit (IC) is disclosed. In one embodiment, the over-voltage detection circuit comprises a first portion and a second portion. In one embodiment, the first portion includes a plurality of MOSFET transistors connected in series to ground, a first resistor connected between a virtual supply voltage (VV_{DD}) and the plurality of MOSFET transistors, and a first inverter with an input connected between the first resistor and the plurality of transistors, where VV_{DD} is a scaled down version of voltage applied to the IC (V_{DD}). In one embodiment, the second portion includes a second transistor connected to V_{DD} applied to the IC, a pair of MOSFET transistors connected in series between the second transistor and ground, and a second inverter with an input connected between the second resistor and the pair of MOSFET transistors. In one embodiment, a gate of a first one of the pair of MOSFET transistors is connected to VV_{DD} and a gate of a second one of the pair of MOSFET transistors is connected to an output of the first inverter. In one embodiment, an output of the second inverter indicates V_{DD} is above an over-voltage level represented by VV_{DD} and the output of the second inverter is provided to other portions of the IC.

In another aspect, an integrated circuit (IC) is disclosed. In one embodiment, the IC comprises at least one processor and at least one input. In one embodiment, the at least one input includes an over-voltage detection circuit. In one embodiment, the over-voltage detection circuit comprises a first portion and a second portion. In one embodiment, the first portion includes a plurality of MOSFET transistors connected in series to ground, a first resistor connected between a virtual supply voltage (VV_{DD}) and the plurality of MOSFET transistors, and a first inverter with an input connected between the first resistor and the plurality of transistors, where VV_{DD} is a scaled down version of voltage applied to the IC (V_{DD}). In one embodiment, the second portion includes a second transistor connected to V_{DD} applied to the IC, a pair of MOSFET transistors connected in series between the second transistor and ground, and a second inverter with an input connected between the second resistor and the pair of MOSFET transistors. In one embodiment, a gate of a first one of the pair of MOSFET transistors is connected to VV_{DD} and a gate of a second one of the pair of MOSFET transistors is connected to an output of the first inverter. In one embodiment, an output of the second inverter indicates V_{DD} is above an over-voltage level represented by VV_{DD} and the output of the second inverter is provided to other portions of the IC.

In yet another aspect, a method of detecting over-voltage on an input of an integrated circuit (IC) is disclosed. In one embodiment, the method comprises scaling down a voltage supplied to the IC (V_{DD}) to a virtual supply voltage (VV_{DD}), detecting VV_{DD}, translating VV_{DD} back to V_{DD}, and indicating when V_{DD} is above an over-voltage level based on the translation of VV_{DD} to V_{DD}.

In still another aspect, a library of designs is disclosed. In one embodiment, the library of designs comprises a design for an over-voltage detection circuit for use with an integrated circuit (IC). In one embodiment, the over-voltage detection circuit comprises a first portion and a second portion. In one embodiment, the first portion includes a plurality of MOSFET transistors connected in series to ground, a first resistor connected between a virtual supply voltage (VV_{DD}) and the plurality of MOSFET transistors, and a first inverter with an input connected between the first resistor and the plurality of transistors, where VV_{DD} is a scaled down version of voltage applied to the IC (V_{DD}). In one embodiment, the second portion includes a second transistor connected to V_{DD} applied to the IC, a pair of MOSFET transistors connected in series between the second transistor and ground, and a second inverter with an input connected between the second resistor and the pair of MOSFET transistors. In one embodiment, a gate of a first one of the pair of MOSFET transistors is connected to VV_{DD} and a gate of a second one of the pair of MOSFET transistors is connected to an output of the first inverter. In one embodiment, an output of the second inverter indicates V_{DD} is above an over-voltage level represented by VV_{DD} and the output of the second inverter is provided to other portions of the IC.

In still yet another aspect, an over-voltage detection circuit for use with an integrated circuit (IC) is disclosed. In one embodiment the over-voltage detection circuit comprises a first portion configured to scale down a voltage supplied to the IC (V_{DD}) to a virtual supply voltage (VV_{DD}) and a second portion configured to translate VV_{DD} back to V_{DD} and indicate when V_{DD} is above an over-voltage level based on the translation of VV_{DD} to V_{DD}.

### BRIEF DESCRIPTION OF THE DRAWINGS

Reference is now made to the following descriptions taken in conjunction with the accompanying drawings, in which:

FIG. 1 illustrates a block diagram of an example of an integrated circuit (IC) according to the principles of the disclosure;

FIG. 2 illustrates a block diagram of an example of an IC with over-voltage detection circuits according to principles of the disclosure;

FIG. 3 illustrates a schematic of an example of an embodiment of a cross-domain glitch detection circuit;

FIG. 4 illustrates a supply voltage profile for an example of an embodiment of a cross-domain glitch detection circuit;

FIG. 5 illustrates a schematic of an example of a voltage divider for an embodiment of an over-voltage detection circuit according to principles of the disclosure;

FIG. 6 illustrates a schematic of an example of an embodiment of an over-voltage detection circuit according to principles of the disclosure;

FIG. 7 illustrates an example of a voltage profile for an embodiment of an over-voltage detection circuit according to principles of the disclosure; and

FIG. 8 illustrates an example of a flow diagram of an example of a method of detecting over-voltage applied to an input of an integrated circuit IC according to principles of the disclosure.

### DETAILED DESCRIPTION OF THE DISCLOSURE

In order to address the above-described over-voltage attack, it is desirable to have a fast and accurate system and method that can detect when voltage levels applied to inputs of the IC, e.g., supply voltage pads of the IC, are above specified values that would enable the unauthorized access by hackers as described above. Many ICs already include voltage monitoring circuitry that can monitor a voltage on supply voltage pads and can determine a voltage level of a voltage applied to those supply voltage pads of the IC. However, this voltage monitoring circuitry is usually clocked by a clock signal. That is, the voltage monitoring actually only occurs based on a clock signal applied to the voltage monitoring circuitry. When the applied clock signal is high, voltage is monitored but, when the applied clock signal is low, the voltage monitoring circuitry does not monitor the voltage applied to the supply voltage pads of the IC. Even for a very high clock frequency, the period in which the voltage monitoring circuitry does not monitor the voltage can be long enough to allow a hacker to unauthorized access to the IC. For example, if the clock signal is a 50 GHz signal, the voltage monitoring circuitry will not monitor voltage for 20 ps.

Thus, it is desirable to have an over-voltage monitoring circuit and method that is not clocked (i.e., has zero latency) so that the over-voltage monitoring circuit instantaneously monitors voltages applied to various supply voltage pads of the IC.

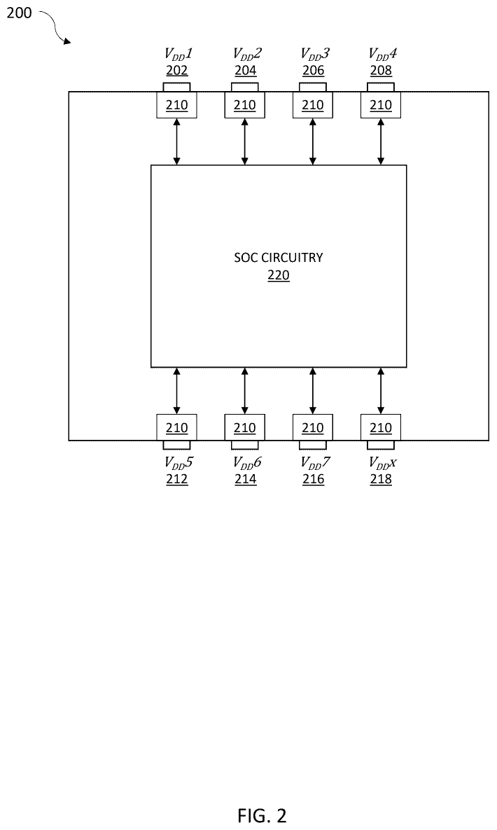

Generally, SoCs have multiple voltage domains, each operating at a different voltage. Various voltage domains may include, e.g., voltage domains for a real-time clock (RTC), CPU(s), GPU(s), and other logic block(s) of the SoC IC, etc. In such SoC ICs, as disclosed in the '788 application, cross-domain glitch detection circuitry is used which allows for glitch detection across multiple voltage domains. This cross-domain glitch detection circuitry can be modified to detect the above-described “over-voltage attack” as disclosed below. In one embodiment, a virtual supply voltage (VV_{DD}) replaces a voltage supplied to the glitch detector portions of the cross-domain glitch detection circuitry (e.g., glitch detection circuit 202 of glitch detection circuit 200 of FIG. 2 of the '788 application) while another supply voltage V_{DD} is applied to the inverter circuitry (e.g., inverter circuitry 206 of glitch detection circuit 200 of FIG. 2 of the '788 application) as disclosed below.

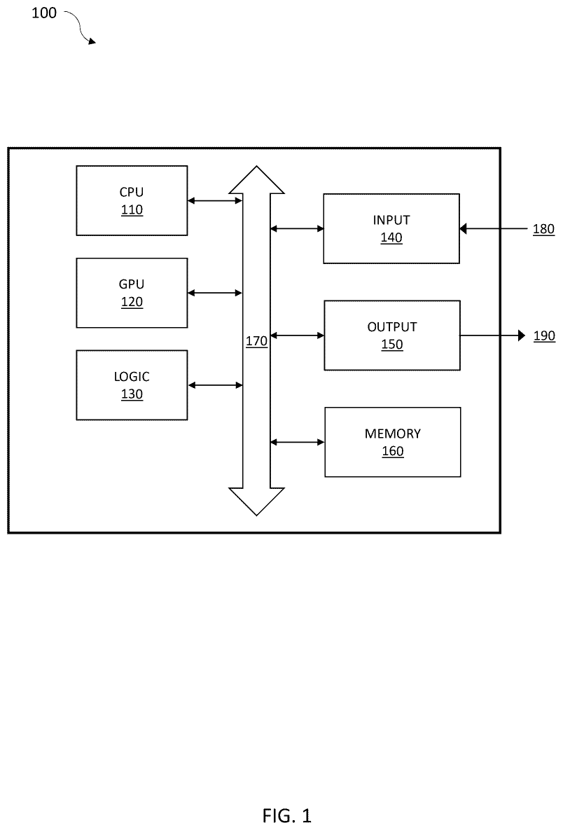

Referring to the drawings, specifically FIG. 1, a block diagram of an example of an embodiment of integrated circuit (IC) 100 constructed according to the principles of the disclosure is shown. IC 100 includes at least one CPU 110, at least one GPU 120, optionally at least one logic block 130, input circuitry 140, output circuitry 150, and memory 160. Of course, in some embodiments IC 100 can include more than one CPU 110, GPU 120, or logic block 130 or, in other embodiments, IC 100 could omit any of CPU 110, GPU 120, or logic block 130. As depicted in FIG. 1, in some embodiments, CPU 110, GPU 120, logic block 130, input circuitry 140, output circuitry 150, and memory 160 communicate with each other over bus 170. In some embodiments, additional busses between different processing units (e.g., CPU 110, GPU 120, and logic block 130) and between different processing units (e.g., CPU 110, GPU 120, and logic block 130), input circuitry 140, output circuitry 150, and memory 160 can be employed (not shown). Memory 160 can be comprised of differing types of volatile memories (e.g., dynamic random access (DRAM) memory, SRAM memory, etc.) and/or non-volatile memories (e.g., read-only memory (ROM), erasable programmable read-only memory (EPROM), electrically erasable programmable read-only memory (EEPROM), flash memory, etc.). Also as depicted in FIG. 1, IC 100's input circuitry 140 accepts signals 180 externally provided to IC 100 and IC 100's output circuitry 150 provides signals 195 external to IC 100.

FIG. 2 illustrates an example of an embodiment of a block diagram of an IC 200 (e.g., a SoC IC, similar to IC 100 of FIG. 1) with over-voltage detection circuitry constructed according to principles of the disclosure. IC 200 includes a plurality of supply voltage pads 202, 204, 206, 208, 212, 214, 216, and 218 on which supply voltages V_{DD1}, V_{DD2}, V_{DD3}, V_{DD4}, V_{DD5}, V_{DD6}, V_{DD7}, and V_{DDx}, respectively, are applied to IC 200. While the example block diagram of IC 200 depicts eight supply voltage pads for eight differing supply voltages, any number of supply voltage pads and corresponding supply voltages can be applied to IC 200. Further, while the example block diagram of IC 200 depicts supply voltage pads located on two sides of IC 200, supply voltage pads can be located on any side of IC 200. Each supply voltage pad of IC 200 (e.g., supply voltage pads 202, 204, 206, 208, 212, 214, 216, and 218) is connected to a corresponding over-voltage detection circuit 210, each of which in turn is connected to SoC circuitry 220. As with IC 100, SoC circuitry 220 of IC 200 can include a plurality of CPU(s), GPU(s), logic block(s), input circuitry, output circuitry, and memory, similar to CPU(s) 110, GPU(s) 120, logic block(s) 130, input circuitry 140, output circuitry 150, and memory 160 of IC 100 of FIG. 1.

Supply voltages V_{DD1}, V_{DD2}, V_{DD3}, V_{DD4}, V_{DD5}, V_{DD6}, V_{DD7}, and V_{DDx} can supply different voltage domains for any portions of circuitry of SoC circuitry 200, e.g., CPU(s), GPU(s), logic block(s), input circuitry, output circuitry, and memory. Over-voltage detection circuits 210 detect the above-described over-voltage attack, thereby preventing hackers from unauthorized access to the IC, e.g., IC 200.

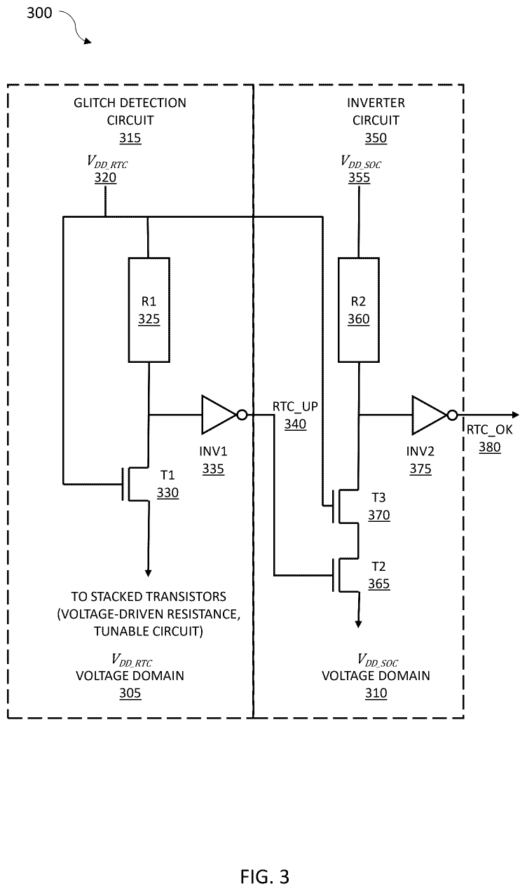

As discussed above, the '788 application discloses a cross-domain glitch detection circuitry, used for glitch detection across multiple voltage domains and is modified herein to provide the disclosed over-voltage method and detection circuit, e.g., over-voltage detection circuit 210. Cross-domain glitch detection circuit 200 of FIG. 2 of the '788 application is depicted in FIG. 3 and described below. In the example of the cross-domain glitch detection circuit 300 of FIG. 3, the two voltage domains from which glitch detection is determined are a voltage domain for a real-time clock (RTC), e.g., V_{DD_RTC} voltage domain 305, and a voltage domain for SoC circuitry, e.g., V_{DD_SOC} voltage domain 310. Of course, any two voltage domains with supply voltages, such as those, e.g., listed above, (e.g., V_{DD1}, V_{DD2}, V_{DD3}, V_{DD4}, V_{DD5}, V_{DD6}, V_{DD7}, and V_{DDx}) could be used for the two voltage domains from which glitch detection is determined by cross-domain glitch detection circuit 300 of FIG. 3.

Cross-domain glitch detection circuit 300 comprises glitch detection circuit 315 and inverter circuit 350. Glitch detection circuit 315 may be coupled to a supply voltage for a real-time clock (e.g., supply voltage V_{DD_RTC} 320) in the voltage domain to be sensed for a glitch attack (e.g., RTC V_{DD_RTC} voltage domain 305). The output of glitch detection circuit 315, signal RTC_UP 340, may drive pull-down transistor T2 365 of inverter circuit 350 in a different voltage domain (e.g., SoC V_{DD_SOC} voltage domain 310), thus coupling the different domain of the supply voltage of the domain under glitch attack (e.g., RTC V_{DD_RTC} voltage domain 305).

Inverter circuit 350 may operate as a voltage level translator and may comprise second pull-up resistor R2 360, pull-down transistor T2 365, and enabling transistor T3 370 connected in series, where each of transistors T2 365 and T3 370 may be an NMOS or PMOS transistor. The output of glitch detection circuit 315, signal RTC_UP 340, may drive pull-down transistor T2 365 of inverter circuit 350. A “pull-up resistor” refers to a resistor used to ensure a known state for a signal. For a switch that connects to ground, a pull-up resistor ensures a well-defined voltage (e.g., V_{DD}) across the remainder of the circuit when the switch is open.

Referring to cross-domain glitch detection circuit 300, a voltage of the RTC domain (the first voltage domain), V_{DD_RTC} 320, is coupled, either directly or indirectly, to a gate of transistor T1 330 of V_{DD_RTC} domain 305. Transistor T1 330 may be a single transistor (shown) or may be a plurality of transistors in series (not shown) or other switching circuit and may be NMOS or PMOS transistor(s). A series of stacked transistors may be utilized to provide a voltage-driven resistance, thus providing field-tunable circuit.

V_{DD_RTC} 320 is also coupled, either directly or indirectly, to first pull-up resistor 325. First inverter INV1 335 may be coupled to a junction node of first pull-up resistor R1 325 and first pull-down transistor T1 330. First pull-down transistor 330 may also be coupled, either directly or indirectly, to other devices in V_{DD_RTC} voltage domain 305, such as a stack of additional transistors. The output signal from INV1 335 is signal RTC_UP 340, which is passed to inverter circuit 350 in V_{DD_SOC} voltage domain 310.

Referring to inverter circuit 350, RTC_UP 340 signal from V_{DD_RTC} voltage domain 305 is coupled, either directly or indirectly, to a gate of second pull-down transistor T2 365 of V_{DD_SOC} voltage domain 310 (the second voltage domain). Supply voltage V_{DD_SOC} 355 for the second voltage domain may be coupled, either directly or indirectly, to second pull-up resistor R2 360 in series with second pull-down transistor T2 365 and enabling transistor T3 370.

Second inverter INV2 375 may be coupled to a junction node of second pull-up resistor R2 360 and enabling transistor T3 370. Second pull-down transistor T2 365 may be coupled, either directly or indirectly, to other devices in V_{DD_SOC} voltage domain 310. The output signal from second inverter INV2 375 is RTC_OK signal 380, which indicates whether an alert should be triggered in V_{DD_SOC} voltage domain 310 indicating a potential glitch attack.

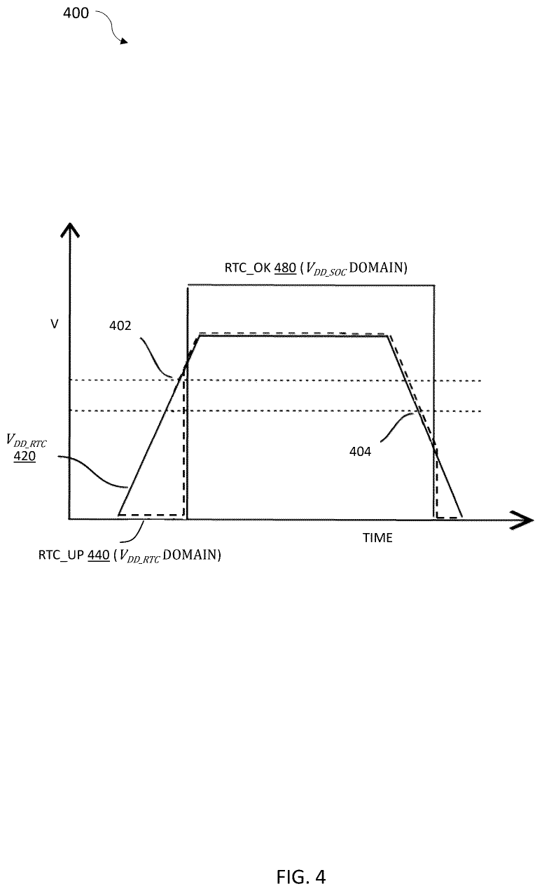

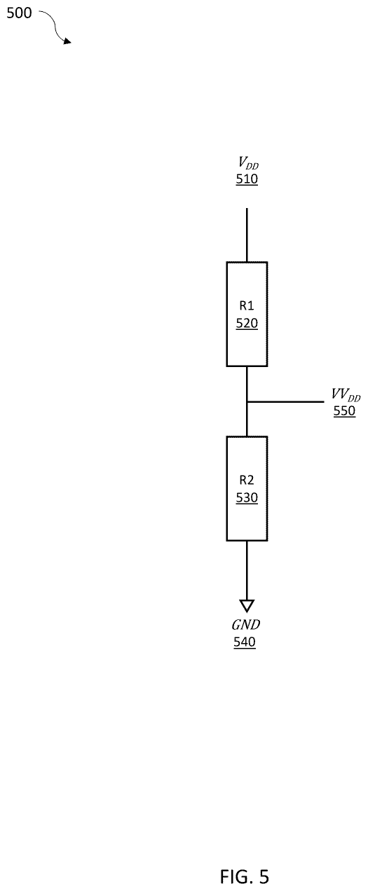

Referring to FIG. 4 (similar to FIG. 5 of the '788 application), a supply voltage profile 400 that may be generated by the cross-domain glitch detection circuit discussed above is shown. A supply voltage V_{DD_RTC} 420 (in V_{DD_RTC} voltage domain 305 of FIG. 3), when applied to the cross-domain glitch detection circuit, may generate RTC_UP 440 signal (similar to the RTC_UP 340 signal discussed above in FIG. 3) that is passed an inverter circuit, e.g., inverter circuit 350 of FIG. 3, and used to drive second pull-down transistor T2 365 of FIG. 3 in V_{DD_SOC} voltage domain 310. When supply voltage V_{DD_RTC} 420 is at an operationally normal value (e.g., 0.75V), RTC_UP signal 440 is high, second pull-down transistor T2 365 is on and RTC_OK signal 380 that equals 1 is generated in V_{DD_SOC} voltage domain 310 when enabling transistor T3 370 is turned on by supply voltage V_{DD_RTC} 420.

When supply voltage V_{DD_RTC} 420 is below a threshold value, then RTC_UP 440 signal is zero. Second pull-down transistor T2 365 in inverter circuit 350 is off, and an RTC_OK signal 480 equals 0 is generated in V_{DD_SOC} voltage domain 310. When the value of RTC_OK signal 480 equals 0, an alert may be triggered in V_{DD_SOC} voltage domain 310 based on an irregular voltage in V_{DD_RTC} voltage domain 305.

As supply voltage profile 400 illustrates, supply voltage V_{DD_SOC} 420 remains within a normal operating range during the glitch, as is demonstrated by a profile of RTC_OK signal 480. But for the potential alert being triggered by a glitch in V_{DD_RTC} voltage domain 305, V_{DD_SOC} voltage domain 310 may remain unaware of the glitch.

In various embodiments, there is a trip voltage V_trip_up 402 for a ramping up voltage in V_{DD_RTC} voltage domain 305, and a trip voltage V_trip_down 404 for a ramping down voltage in V_{DD_RTC} voltage domain 305. If supply voltage V_{DD_RTC} 420 is greater than V_trip_up 402, then the RTC_OK signal 480 is 1, indicating that no glitch has been detected. If supply voltage V_{DD_RTC} 420 is less than V_trip_down 404, then the RTC_OK signal 480 is 0, indicating that a glitch may have been detected and that an alert may need to be generated in V_{DD_SOC} voltage domain 310.

In an embodiment, it is possible to glitch supply voltage V_{DD_RTC} 420 outside of the trigger points. This may occur if the glitch voltage is greater than V_trip_up 402 and greater than V_trip_down 404.

As noted above the cross-domain glitch detection circuitry of the '788 application is used for glitch detection across multiple voltage domains, e.g., V_{DD_RTC} voltage domain 305 and V_{DD_SOC} voltage domain 310 of FIG. 3 discussed above. However, to detect the above-described over-voltage attack of supply voltage inputs (e.g., the above-disclosed supply voltage pads) of the SoC IC, e.g., SoC IC 200 of FIG. 2, rather than using two different voltage domains in the cross-domain glitch detection circuitry of FIG. 3, only one voltage domain and it's single supply voltage and a derivative thereof are applied similarly to the cross-domain glitch detection circuitry of the '788 application and FIG. 3 (thus, the cross-domain glitch detection circuitry becomes the disclosed over-voltage detection circuitry, e.g., over-voltage detection circuit 210 of FIG. 2).

The derivative of the single voltage domain (and the single supply voltage) is, in some embodiments, the virtual V_{DD} (e.g., VV_{DD}) disclosed above. Generally speaking, by using a derivative of the single voltage domain used in the disclosed over-voltage detection circuitry, the voltage trip point used as described above (e.g., V_trip_up 402 of FIG. 4 disclosed above) is increased to a level that approximates a voltage level of the above-described over-voltage attack of the supply voltage inputs of the SoC IC. In most embodiments, the voltage level for the virtual V_{DD} voltage supply (e.g., VV_{DD}) is less than the voltage level for supply voltage (e.g., V_{DD}). Moreover, the supply voltage, e.g., V_{DD} can be any of supply voltages V_{DD1}, V_{DD2}, V_{DD3}, V_{DD4}, V_{DD5}, V_{DD6}, V_{DD7}, and V_{DDx} disclosed above.

The virtual supply voltage, e.g., VV_{DD}, is generated, in some embodiments, by voltage divider 500 depicted in FIG. 5. Generally, the trip point for the voltage level deemed to a voltage level of the over-voltage attack is scaled by voltage divider 500 of FIG. 5. Voltage divider 500 includes resistors R1 520 and R2 530 connected in series between supply voltage V_{DD} 510 and ground 540. Virtual V_{DD} voltage supply VV_{DD} 550 is generated at a junction node between resistors R1 520 and R2 530. As disclosed above, the trip point for the disclosed over-voltage detection circuit, e.g., over-voltage detection circuit 210 of FIG. 2, is based on virtual V_{DD} voltage supply VV_{DD} 550. For example, if resistors R1 and R2 are of equal values, then virtual V_{DD} voltage supply VV_{DD} 550 will be half of supply voltage V_{DD} 510. Thus, resistors R1 and R2 can be adjusted to set the voltage level for virtual V_{DD} supply voltage VV_{DD} 550 which in turn adjusts the over-voltage trip point for the disclosed over-voltage detection circuit.

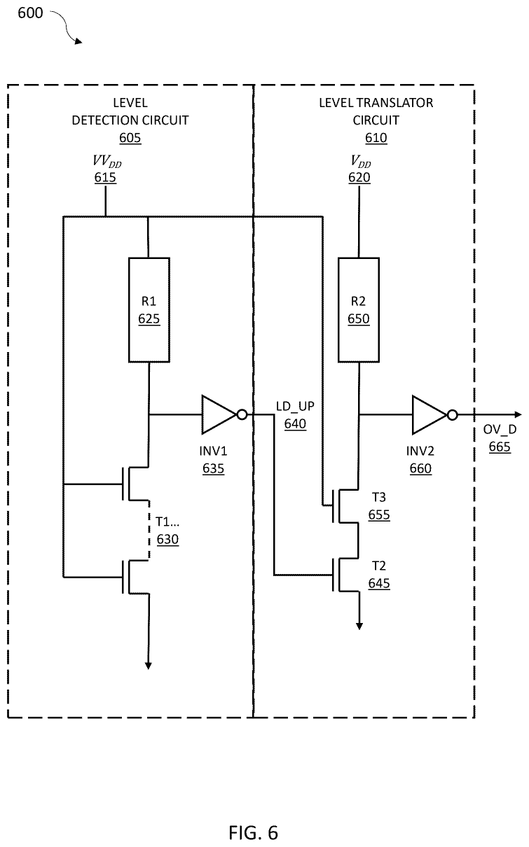

FIG. 6 illustrates a schematic of an example of an embodiment of over-voltage detection circuit 600 constructed according to principles of the disclosure, similar to over-voltage detection circuit 210 of FIG. 2. Over-voltage detection circuit 600 includes level detection circuit 605 and level translator circuit 610. A virtual supply voltage VV_{DD} 615, e.g., similar to VV_{DD} 550 of FIG. 5, is applied to over-voltage detection circuit 600. Any voltage higher than VV_{DD} 615 applied to over-voltage detection circuit 600 (e.g., via supply voltage pads 202, 204, 206, 208, 212, 214, 216, and 218 on, e.g., SoC 200 of FIG. 2—now labeled supply voltage V_{DD} 620) will be considered an over-voltage attack on the SoC and will cause an alert to be generated from over-voltage detection circuit 600 and supplied to other portions of the SoC.

Level detection circuit 605 is coupled to virtual supply voltage VV_{DD} 615 and includes, similar to glitch detection circuit 315 of FIG. 3, first pull-up resistor 625 connected, either directly or indirectly, in series with at least one pull-down transistor T1 630. The embodiment of FIG. 6 depicts two pull-down transistors T1 630 but in other embodiments there are 10-15 pull-down transistors T1 630 connected in series, gates of each which are connected to virtual supply voltage VV_{DD} 615. Pull-down transistors 630, which may be either NMOS or PMOS transistors, are similar to pull-down transistors T1 330 of FIG. 3, where the series of stacked pull-down transistors T1 630 may be utilized to provide a voltage-driven resistance, thus providing a field-tunable circuit.

An input of first inverter INV1 635 of level detection circuit 605 is connected, either directly or indirectly, to a junction node between first pull-up resistor R1 625 of level detection circuit 605 and a first one of the at least one pull-down resistors T1 630 of level detection circuit 605. The output of first inverter INV1 635 (and the output of level detection circuit 605), signal LD_UP 640, drives pull-down transistor T2 645 of level translator circuit 610. Level translator circuit 610 operates as a voltage level translator and comprises second pull-up resistor R2 650, pull-down transistor T2 645, and enabling transistor T3 655 connected in series where each of transistors T2 645 and T3 655 may be an NMOS or PMOS transistor. The gate of enabling transistor T3 is connected, either directly or indirectly, to virtual supply voltage VV_{DD} 615. An input of second inverter INV2 660 of level translator circuit 610 is connected, either directly or indirectly, to a junction node between second pull-up resistor 650 and enabling transistor T3 655. The output of second inverter INV2 660, signal OV_D 665, is an alert signal which indicates an over-voltage attack on the supply voltage pad (e.g., one of the supply voltage pads corresponding to supply voltage V_{DD1} 202, V_{DD2} 204, V_{DD3} 206, V_{DD4} 208, V_{DD5} 212, V_{DD6} 214, V_{DD7} 216, or V_{DDX} 218 of FIG. 2—supply voltage V_{DD} 620). The alert is provided to other portions of the SoC (e.g., CPU(s) 110, GPU (2) 120, logic block(s) 130, input circuitry 140, output circuitry 150, and/or memory 160 of FIG. 1) for a determination of whether an action should be taken by the SoC based on the alert (e.g., SoC reset, etc.).

In operation, over-voltage detection circuit 600 scales the voltage trip point of the cross-domain glitch detection circuit 300 of FIG. 3 higher, e.g., V_trip_up 402 of FIG. 4, by replacing one of the supply voltages applied to the cross-domain glitch detection circuit 300 of FIG. 3 (e.g., supply voltage V_{DD_RTC} 320) with a scaled down version of a single supply voltage V_{DD} 620 (replacing supply voltage V_{DD_SOC} 355). Over-voltage detection circuit 600 now operates to detect when a voltage applied to a single supply voltage, e.g., supply voltage V_{DD} 620 (e.g., supply voltage V_{DD1} 202, V_{DD2} 204, V_{DD3} 206, V_{DD4} 208, V_{DD5} 212, V_{DD6} 214, V_{DD7} 216, or V_{DDX} 218 of FIG. 2) is higher than the voltage trip point (e.g., virtual voltage supply VV_{DD} 615) determined by the voltage divider (e.g., voltage divider 500 of FIG. 5), thereby indicating an over-voltage attack of the specific supply voltage applied to over-voltage detection circuit 600. The indication is the assertion of the signal OV_D 665 output from over-voltage detection circuit 600.

For signal OV_D 665 to be asserted high, both enabling transistor T3 655 and pull-down transistor T2 645 must be turned on and a voltage supplied to supply voltage V_{DD} 620 must be higher than the over-voltage trip point, e.g., virtual supply voltage VV_{DD} 615. When these conditions exist, the voltage at the input to second inverter INV2 660 will be pulled down by enabling transistor T3 655 and pull-down transistor 645 to a voltage level low enough to cause second inverter INV2 660's output signal OV_D 665 to transition high. As disclosed above, pull-down transistor T2 645 will be turned on by signal LD_UP 640 and enabling transistor T3 655 will be turned on when virtual supply voltage VV_{DD} 615 applied to it is high enough to turn it on.

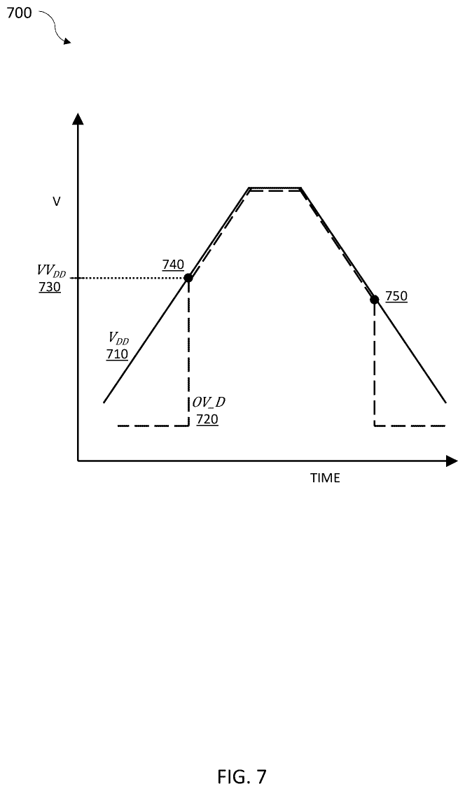

FIG. 7 illustrates an example of a voltage profile 700 for an embodiment of an over-voltage detection circuit, e.g., over-voltage detection circuit 600 of FIG. 6 (or over-voltage detection circuit 210 of FIG. 2). Supply voltage signal V_{DD} 710 is a plot of voltage supplied (e.g., supply voltage V_{DD} 620 if FIG. 6) to an over-voltage detection circuit (e.g., over-voltage detection circuit 600 of FIG. 6 or over-voltage detection circuit 210 of FIG. 2) over time. Over-voltage detect signal OV_D 720 (similar to signal OV_D 665 output from over-voltage detection circuit 600 of FIG. 6) is a plot of a signal indicative of an over-voltage attack of a supply voltage (e.g., supply voltage V_{DD1} 202, V_{DD2} 204, V_{DD3} 206, V_{DD4} 208, V_{DD5} 212, V_{DD6} 214, V_{DD7} 216, or V_{DDX} 218 of FIG. 2) applied to the over-voltage detection circuit over time.

When supply voltage level V_{DD} 710 voltage level is lower than virtual supply voltage VV_{DD} 730 (similar to virtual supply voltage VV_{DD} 615 of FIG. 6), over-voltage detect signal OV_D 720 is low. However, when supply voltage level V_{DD} 710 voltage level reaches virtual supply voltage VV_{DD} 730 at trip point 740, over-voltage detect signal OV_D 720 goes high. When supply voltage level V_{DD} 710 voltage level falls back below virtual supply voltage VV_{DD} 730 at trip point 750, over-voltage detect signal OV_D 720 goes low. In some embodiments (such as that shown in FIG. 7), the voltage at trip point 750 is lower than the voltage at trip point 750. This is because a voltage input to, e.g., second inverter INV2 660 of FIG. 6, to turn second inverter INV2 660 on is higher than a voltage input to second inverter INV2 660 off (a parasitic hysteresis of second inverter 660). As disclosed above, over-voltage detect signal OV_D 720 is provided to other portions of the SoC which determines action to be taken by the SoC upon the assertion of over-voltage detect signal OV_D 720.

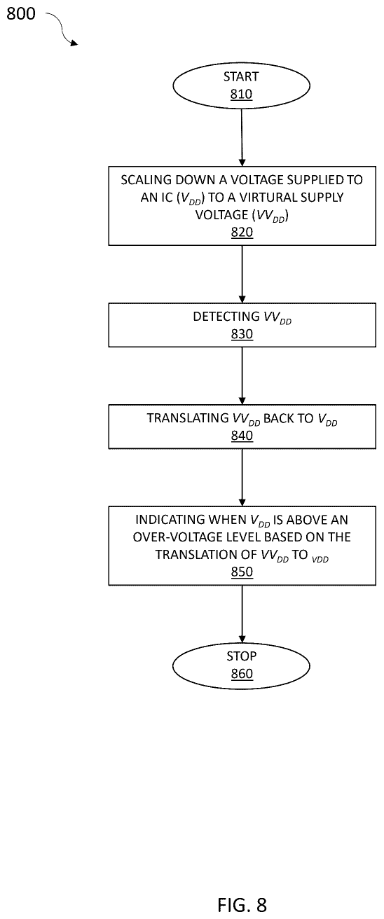

FIG. 8 illustrates an example of a flow diagram of an example of method 800 of detecting over-voltage applied to an input of an integrated circuit IC. Method 800 starts at step 810. At step 820 a voltage supplied to the IC (similar to supply voltage V_{DD} 620 of FIG. 6) is scaled down using, e.g., above-disclosed voltage divider 500. At step 830 a virtual supply voltage (e.g., virtual supply voltage VV_{DD} 615) is detected using, e.g., level detection circuit 605 of over-voltage detection circuit 600 of FIG. 6. At step 840, the virtual supply voltage (e.g., virtual supply voltage VV_{DD} 615) is translated back to the supply voltage (e.g., supply voltage V_{DD} 620 of FIG. 6) using, e.g., level translation circuit 610 of FIG. 6. At step 850, method 800 indicates when the supply voltage (e.g., supply voltage V_{DD} 620 of FIG. 6) is above an over-voltage level (e.g., virtual supply voltage VV_{DD} 615) based on the translation of the virtual supply voltage to supply voltage of step 840.

In some embodiments, a library of circuit designs comprises the above-disclosed over-voltage detection circuit where the over-voltage detection circuit includes the above-disclosed level detection circuit and level translation circuit. In some embodiments, the over-voltage detection circuit of the library of circuit designs operates using a supply voltage and derivative thereof, i.e., the above-disclosed virtual supply voltage.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

What is claimed is:

1. An over-voltage detection circuit for use with an integrated circuit (IC), the over-voltage detection circuit comprising:
a first portion including:
a plurality of MOSFET transistors connected in series to ground,
a first resistor connected between a virtual supply voltage (VV_{DD}) and the plurality of MOSFET transistors, wherein VV_{DD} is a scaled down voltage applied to the IC (V_{DD}), and
a first inverter with an input connected between the first resistor and the plurality of MOSFET transistors; and
a second portion including:
a second resistor connected to V_{DD},
a pair of MOSFET transistors connected in series connected between the second resistor and ground, wherein a gate of a first one of the pair of MOSFET transistors is connected to VV_{DD} and a gate of a second one of the pair of MOSFET transistors is connected to an output of the first inverter, and
a second inverter with an input connected between the second resistor and the pair of MOSFET transistors, wherein an output of the second inverter indicates V_{DD} is above an over-voltage level represented by VV_{DD} and the output of the second inverter is provided to other portions of the IC.

2. The over-voltage detection circuit as recited in claim 1, wherein the IC is reset when the output of the second inverter indicates V_{DD} is above the over-voltage level.

3. The over-voltage detection circuit as recited in claim 1, wherein gates of the plurality of MOSFET transistors are connected to VV_{DD}.

4. The over-voltage detection circuit as recited in claim 1, further comprising a resistor divider connected in series between V_{DD} and ground, wherein the resistor divider comprises two resistors and VV_{DD} is output from the resistor divider.

5. The over-voltage detection circuit as recited in claim 4, wherein VV_{DD} is determined by values of the two resistors in the resistor divider.

6. The over-voltage detection circuit as recited in claim 4, wherein a voltage required to turn the second invertor on is higher than a voltage required to turn the second invertor off, generating a hysteresis voltage band.

7. The over-voltage detection circuit as recited in claim 1, wherein the second inverter indicates V_{DD} is above the over-voltage level in less than about 20 picoseconds after the over-voltage level is applied to the IC.

8. An integrated circuit (IC), comprising:
at least one processor; and
at least one input, the at least one input including an over-voltage detection circuit, the over-voltage detection circuit comprising:
a first portion including:
a plurality of MOSFET transistors connected in series to ground;
a first resistor connected between a virtual supply voltage (VV_{DD}) and the plurality of MOSFET transistors, wherein VV_{DD} is a scaled down voltage applied to the IC (V_{DD}); and
a first inverter with an input connected between the first resistor and the plurality of MOSFET transistors; and
a second portion including:
a second resistor connected to V_{DD} applied to the IC;
a pair of MOSFET transistors connected in series connected between the second resistor and ground, wherein a gate of a first one of the pair of MOSFET transistors is connected to VV_{DD} and a gate of a second one of the pair of MOSFET transistors is connected to an output of the first inverter; and
a second inverter with an input connected between the second resistor and the pair of MOSFET transistors, wherein an output of the second inverter indicates V_{DD} is above an over-voltage level represented by VV_{DD} and the output of the second inverter is provided to other portions of the IC.

9. The IC as recited in claim 8, wherein the IC is reset when the output of the second inverter indicates V_{DD} is above the over-voltage level.

10. The IC as recited in claim 8, wherein gates of the plurality of MOSFET transistors are connected to VV_{DD}.

11. The IC as recited in claim 8, further comprising a resistor divider connected in series between V_{DD} and ground, wherein the resistor divider comprises two resistors and VV_{DD} is output from the resistor divider.

12. The IC as recited in claim 11, wherein VV_{DD} is determined by values of the two resistors in the resistor divider.

13. The IC as recited in claim 11 wherein a voltage required to turn the second invertor on is higher than a voltage required to turn the second invertor off, generating a hysteresis voltage band.

14. The IC as recited in claim 8, wherein the second inverter indicates V_{DD} is above the over-voltage level in less than about 20 picoseconds after the over-voltage level is applied to the IC.

15. A method of detecting over-voltage on an input of an integrated circuit (IC), the method comprising:
scaling down a voltage supplied to the IC (V_{DD}) to a virtual supply voltage (VV_{DD});
detecting VV_{DD};
translating VV_{DD} back to V_{DD}; and
indicating when V_{DD} is above an over-voltage level based on the translation of VV_{DD} to V_{DD}.

16. The method as recited in claim 15, further comprising resetting the IC based on the indication.

17. The method as recited in claim 15, wherein V_{DD} is scaled to VV_{DD} using a resister divider comprising two resisters connected in series between V_{DD} and ground.

18. The method as recited in claim 15, wherein the indication that V_{DD} is above the over-voltage level in less than about 20 picoseconds after the over-voltage level is applied to the IC.

19. A library of circuit designs, comprising:
a design for an over-voltage detection circuit for use with an integrated circuit (IC), the design for the overvoltage detection circuit comprising:
a first portion including:
a plurality of MOSFET transistors connected in series to ground;
a first resistor connected between a virtual supply voltage (VV_{DD}) and the plurality of MOSFET transistors, wherein VV_{DD} is a scaled down voltage applied to the IC (V_{DD}); and
a first inverter with an input connected between the first resistor and the plurality of MOSFET transistors; and
a second portion including:
a second resistor connected to V_{DD} applied to the IC;
a pair of MOSFET transistors connected in series connected between the second resistor and ground, wherein a gate of a first one of the pair of MOSFET transistors is connected to VV_{DD} and a gate of a second one of the pair of MOSFET transistors is connected to an output of the first inverter; and
a second inverter with an input connected between the second resistor and the pair of MOSFET transistors, wherein an output of the second inverter indicates V_{DD} is above an over-voltage level represented by VV_{DD} and the output of the second inverter is provided to other portions of the IC.

20. The library of circuit designs recited in claim 19, wherein the design for the over-voltage detection circuit further comprises a resistor divider connected in series between V_{DD} and ground, wherein:
the resistor divider comprises two resistors,
VV_{DD} is output from the resistor divider, and
VV_{DD} is determined by values of the two resistors in the resistor divider.

21. An over-voltage detection circuit for use with an integrated circuit (IC), the overvoltage detection circuit comprising:
a first portion configured to scale down a voltage supplied to the IC (V_{DD}) to a virtual supply voltage (VV_{DD}); and
a second portion configured to translate VV_{DD} back to V_{DD} and indicate when V_{DD} is above an over-voltage level based on the translation of VV_{DD} to V_{DD}.
